(19) United States
(12) Patent Application Publication
(10) Pub. No.: US 2008/0177631 A1
(43) Pub. Date: Jul. 24, 2008

(54) Methods, devices and systems for taxable basis implementation

(75) Inventor: Isaac J. WILLIAM, Santa Clara, CA (US)

Correspondence Address: YOUNG LAW FIRM, P.C., 4370 ALPINE RD., STE. 106, PORTOLA VALLEY, CA, 94028, US

(73) Assignee: Oracle International Corporation, Redwood Shores, CA (US)

(21) Appl. No.: 12/024,063

(22) Filed: Jan. 31, 2008

Related U.S. Application Data
(63) Continuation-in-part of application No. 10/617,327, filed on Jul. 9, 2003.
Application No. 10/617,327 is a continuation-in-part of application No. 10/617,349, filed on Jul. 9, 2003.
Application No. 10/617,349 is a continuation-in-part of application No. 10/106,729, filed on Mar. 26, 2002.
(60) Provisional application No. 60/398,767, filed on Jul. 26, 2002.
(60) Provisional application No. 60/398,769, filed on Jul. 26, 2002.

(51) Int. Cl. G06Q 30/00

(52) U.S. Cl. 705/14; 705/16

(57) ABSTRACT

A computer-implemented method of determining taxable basis amounts for a plurality of applicable taxes for a transaction line having a line amount includes steps of providing and evaluating a plurality of taxable basis formulae, one taxable basis formula for each of the plurality of applicable taxes that includes at least one of inclusive and exclusive taxes. Each of the list of applicable taxes may be compounded with one or more of applicable taxes, may be a surcharge of one or more of applicable taxes, may be neither compounded nor surcharged; and may be affected by a base rate modifier and/or additional charges or discounts allocated to the transaction line. The plurality of taxable basis formulae may be configured to derive an adjusted line amount such that the sum of the adjusted line amount and tax amounts of the inclusive taxes equals the line amount of the transaction. The plurality of taxable basis formulae may be stored in a database. One of the stored taxable basis formulae may then be selected and applied to a line amount of the transaction to compute the taxable basis of transaction, which may then be stored in the database.

### CROSS-REFERENCE TO RELATED APPLICATIONS

This application is a continuation-in-part of application Ser. No. 10/617,327, filed Jul. 9, 2003, which claims the benefit of Provisional Application No. 60/398,767, filed Jul. 26, 2002, and a continuation-in-part of application Ser. No. 10/617,349, filed Jul. 9, 2003, which claims the benefit of Provisional Application No. 60/398,769, filed Jul. 26, 2002, and a continuation-in-part of application Ser. No. 10/106,729, filed Mar. 26, 2002, all applications of which are hereby incorporated herein by reference in their entireties and from which priority is hereby claimed under 35 U.S.C. §119 and §1.20. This application is related in subject matter to another continuation-in-part application filed on even date herewith entitled, “Methods, devices and systems for sharing and selectively overriding tax configurations.”

### BACKGROUND OF THE INVENTION

The present inventions relate to computer-based systems for calculating taxes. More specifically, the present invention relates to methods, devices and systems for determining the taxable basis (the adjusted line amount) of a line item with inclusive, exclusive and/or compounded taxes.

### SUMMARY OF THE INVENTION

According to an embodiment thereof, the present invention is a computer-implemented method of determining taxable basis amounts for a plurality of applicable taxes for a transaction line having a line amount. The computer-implemented method may include steps of providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction; storing the plurality of taxable basis formulae in a database; selecting one of the stored taxable basis formulae for each of the applicable taxes for the transaction line; applying the selected taxable basis formula to a line amount of the transaction to compute the taxable basis of the transaction, and storing the taxable basis of each of the applicable taxes of the transaction line in the database.

The selecting step may include evaluating a plurality of taxable basis formula determination rules. The selecting step may be carried out by selecting a default taxable basis formula. The plurality of applicable taxes may include a tax that is a surcharge of at least one other applicable tax, and wherein the providing step is carried out with at least one of the plurality of taxable basis formulae including the surcharge. The transaction line may include at least one discount, and wherein at least one of the plurality of taxable basis formulae specifies a subtraction of the at least one discount. The transaction line may include at least one charge, and at least one of the plurality of taxable basis formulae may specify an addition of the at least one charge. The plurality of applicable taxes may include a tax that specifies a base rate modifier, and the providing step may be carried out with at least one of the plurality of taxable basis formulae including the base rate modifier. The method may include a step of assigning compounding precedence to taxes that are compounded such that a tax to which a lower compounding precedence has been assigned cannot be compounded by a tax to which a higher compounding precedence has been assigned and wherein the taxable basis formulae determining step is carried out respecting the assigned compounding precedence. The selecting step may include obtaining at least one of a tax, a tax regime, a formula type, a taxable basis type for the transaction. For the at least one of the plurality of applicable that includes inclusive taxes, the adjusted line amount may be equal to the line amount of the transaction divided by one plus the contributions from inclusive taxes to the taxable basis amount. The method may further include a step of, for at least one of the plurality of applicable taxes, computing a net multiplier for each of the inclusive taxes, the net multiplier being configured such that, for each inclusive tax, the line amount multiplied by the net multiplier yields the contribution to the taxable basis amount from the inclusive tax. The method may also include a step of associating each of the plurality of taxable basis formulae with a tax regime and storing the associated tax regime in the database. At least one of the plurality of applicable taxes for the transaction line may include one nor more of the following: at least one inclusive tax that is compounded with at least one of the plurality of applicable taxes, at least one inclusive tax that is a surcharge of at least one of the plurality of applicable taxes, at least one inclusive tax that that is affected by a base rate modifier; at least one inclusive tax that is affected by additional charges and/or discounts that are allocated to the transaction line, and an inclusive tax for which the adjusted line amount for that tax is not affected by itself or other inclusive taxes. The providing steps may be carried out with at least one of the plurality of taxable basis formulae computing the taxable basis amount to be the line amount for inclusive taxes.

According to another embodiment thereof, the present invention is a computer system for determining a taxable basis amount in a transaction having a line amount, the computer system comprising: at least one processor; at least one data storage device coupled to the at least one processor; a plurality of processes spawned by said at least one processor, the processes including processing logic for: providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction; storing the plurality of taxable basis formulae in a database; selecting one of the stored taxable basis formulae for each of the applicable taxes for the transaction line; applying the selected taxable basis formula to a line amount of the transaction to compute the taxable basis of the transaction, and storing the taxable basis of each of the applicable taxes of the transaction line in the database.

According to yet another embodiment thereof, the present invention is a machine-readable medium having data stored thereon representing sequences of instructions which, when executed by a computing device, causes the computing device to determine a taxable basis amount in a transaction having a line amount, by performing the steps of: providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction; storing the plurality of taxable basis formulae in a database; selecting one of the stored taxable basis formulae for each of the applicable taxes for the transaction line; applying the selected taxable basis formula to a line amount of the transaction to compute the taxable basis of the transaction, and storing the taxable basis of each of the applicable taxes of the transaction line in the database.

### BRIEF DESCRIPTION OF THE DRAWINGS

FIG. 1 illustrates a distributed computer system in accordance with an embodiment of the present invention.

FIG. 2 illustrates the structure of a tax service in accordance with an embodiment of the present invention.

FIG. 3 shows examples of the computation and use of the Net Multiplier according to embodiments of the present invention.

FIG. 4 is a block diagram of a computer with which embodiments of the present invention may be practiced.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

### DEFINITIONS

Tax Jurisdiction: a zone in which a tax type is levied by a specific tax authority. e.g.: the tax jurisdiction for income tax in the United States is the country of the United States; the tax jurisdiction for a San Jose City Tax is the City of San Jose.

Taxable Event: a transaction that incurs a tax liability.

Tax Regime: the set of tax rules that determines the treatment of one or more taxes that have been grouped by a tax authority for administrative other purpose. For example, the Excise Tax Regime in India includes rules for Excise Tax, Additional Excise Tax; VAT Regime in Argentina includes rules for Standard VAT, Additional VAT, and Perception VAT.

Taxable Basis: The base amount upon which a tax is computed.

### Overview of Taxes and Jurisdictions

To understand what a jurisdiction is, a brief description and a few examples of jurisdictions are provided. Each country can have one or more systems of taxation, each of which deals with the taxation of specific aspects of a business transaction. For example, a “Sales” type of taxation system deals with the rules and regulations of how a sales transaction should be taxed. Similarly, a “Value Added Tax” (or, “VAT”) type of taxation system deals with how the value addition in a manufacturing and/or sales lifecycle needs to be taxed. This system of rules and regulations is called a tax regime. A tax regime is implemented by one or more distinct charges. Each such specific charge is called a tax. Therefore, a regime may include one or more different taxes. The imposition of a tax is limited typically by a geographical and/or political boundary, in most cases around a contiguous political/administrative area, such as a city or a county. However, in some cases, a tax may be imposed, or may vary owing to belonging to a non-political demarcation, such as a free-trade zone. The incidence of a tax on a geographical area is called a tax jurisdiction.

A jurisdiction may be created for a country, a state within a country, a county within a state, or a city within a county. In certain cases, a jurisdiction may need to encompass, for example, a couple of cities; or, a county and an adjoining city belonging to a neighboring county. Or, as explained above, jurisdictions may be created for areas such as free-trade zones, export processing zones, etc. Jurisdictions may be created that encompass multiple countries that have banded together to form an economic union.

TABLE 1

| Country | Tax Regime | Tax | Tax Type | Tax Jurisdiction |
|---|---|---|---|---|
| United States | Sales Tax | State Sales Tax | Sales Tax | State |
| | Sales Tax | District Tax | Sales Tax | City |
| Canada | Goods and Services Tax | GST | VAT | Country |
| | Goods and Services Tax | HST | VAT | Province |
| | Sales Tax | PST | Sales Tax | Province |
| Singapore | Goods and Services Tax | GST | VAT | Country |
| India | Excise and Customs | Excise Tax | VAT | Country |
| | Excise and Customs | Additional Excise Tax | VAT | Country |
| | Excise and Customs | Customs Duty | Customs | Country |
| Brazil | RICMS-ICMS Rules | ICMS | VAT | State |
| | RICMS-ICMS Rules | ICMS-ST | VAT | State |
| | RIPI-IPI Rules | IPI | VAT | Country |
| | RII-II Rules | II | Customs | Country |
| Portugal | VAT | Domestic VAT | VAT | Country |
| Portugal | VAT | Inter-EU VAT | VAT | Country |

Table 1 illustrates different exemplary tax regimes, tax jurisdictions, and taxes for different countries. Table 1, reading from left to right, goes from the highest level to the most detailed level of granularity. There may be one or more tax regimes in a country; each regime can consist of one or more taxes; each tax is of a given tax type, which is a high level classification such as Sales Tax, Excise Tax and Mineral Oil Tax; and each tax can be levied in one or more tax jurisdictions (for one or more geographical elements).

### Distributed Computer System

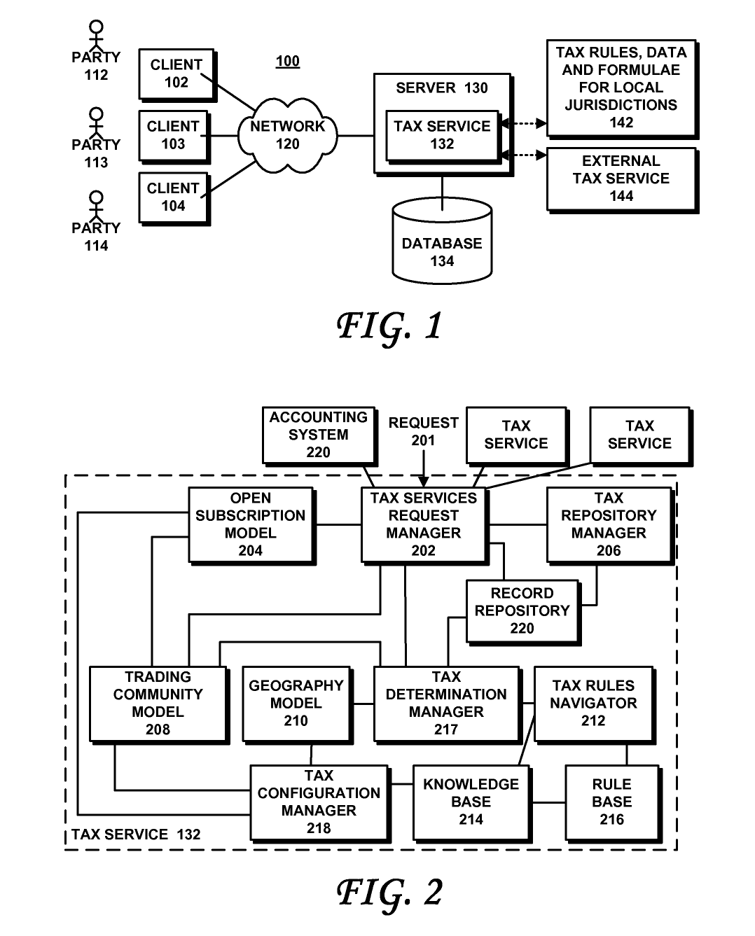

FIG. 1 illustrates distributed computer system 100 in accordance with an embodiment of the present invention. Distributed computer system 100 includes a number of clients 102-104 coupled to a server 130 through a network 120. Clients 102-104 can generally include any device on a network including computational capability and including a mechanism for communicating across the network. Clients 102-104 operate under control of parties 112-114, respectively. (Note that the term “parties” here refers to users of the computer system; it is not the same as the parties involved in taxable transactions.)

Server 130 can generally include one or more (interconnected) computing devices, including a mechanism for servicing requests from clients 102-104 for computational and/or data storage resources. Note that clients 102-104 and server 130 can generally include any type of computing device, including, but not limited to, a computer system based on a microprocessor, a mainframe computer, a digital signal processor, a portable computing device, a personal organizer, a device controller, and a computational engine within an appliance.

Network 120 can generally include any type of wire or wireless communication channel capable of coupling together computing nodes. This includes, but is not limited to, a local area network, a wide area network, or a combination of networks. In one embodiment of the present invention, network 120 includes the Internet.

Server 130 is coupled to a database 134, which contains data that is used by applications running on server 130. Note that these server-based applications may be running on behalf of remote applications on clients 102-104. Database 134 can generally include any type of system for storing data in non-volatile storage. This includes, but is not limited to, systems based upon magnetic, optical, and magneto-optical storage devices, as well as storage devices based on flash memory and/or battery-backed up memory.

Server 130 acts as a host machine for tax service 132. This allows applications running on clients 102-104 to make requests across network 120 to tax service 132 running on server 130. For example, an application running on client 102 can send a request to tax service 132 to perform a tax calculation such as, for example, the determination of taxable basis for taxable events on which inclusive, exclusive and/or compounded taxes have been imposed, according to embodiments of the present inventions.

Note that tax service 132 may be configured so that it can optionally receive tax rules and data for local jurisdictions 142 from an external source, such as a tax expert for the local jurisdiction, prior to a request such as made by clients 102-104. Further, tax service 132 may be configured to use tax rules and data received from an external source in servicing a request from a client. Furthermore, tax rules and data 142 can be encoded in a published format, such as extensible markup language (XML) or electronic data interchange (EDI) format, to facilitate receiving the tax rules and data 142 from different sources. Note that tax rules and data 142 can be communicated to tax service 132 across network 120.

Tax service 132 may be additionally configured so that it may operate with an external tax service 144 provided by an external tax service provider. In this way, the external tax service provider can service the request with an operation (internal to tax service 144), such as a database lookup of a tax rate or a tax computation, in order to facilitate completing a tax operation for a specific jurisdiction by tax service 132. Furthermore, note that this external tax service provider may be located on a remote server that is accessible through network 120. A given request can be partially fulfilled by tax service 132 using tax rules and data 142 for one or more local jurisdictions, while using the tax service 144 of an external tax service provider to perform the computations for another local jurisdiction that might be simultaneously applicable.

### Tax Service Structure

FIG. 2 illustrates the structure of tax service 132 in accordance with an embodiment of the present invention. Tax service 132 includes a number of modules, including Tax Services Request Manager (TSRM) 202, open subscription module 204, tax repository manager 206, Trading Community Architecture (TCA) model 208, geography model 210, tax determination manager 217, tax rules navigator 212, tax configuration manager knowledge base 214, and rule base 216.

TSRM 202 generally manages interactions between external business transactions and tax processing operations. In one embodiment of the present invention, TSRM 202 is implemented as a set of published services that an external business application running on clients 102-104 may request. As is illustrated in FIG. 2, TSRM 202 receives a request 201 to perform a tax processing operation from an application running on one of clients 102-104.

Open subscription model 204 defines the security and access protocols used by TSRM 202 as well as tax rules navigator 212, tax determination manager (TDM) 217, tax configuration manager (TCM) 218 and tax administration manager 222. It also allows subscribers, such as parties 112-114, to select, request and receive tax services other legal entities, other tax content owners and/or from either tax service 132 and/or various external service providers, such as tax service 144. During operation, open subscription module 204 may, according to some implementations, communicate with trading community model 208, which represents various parties, sites and locations involved in the tax operations in a standardized format.

Tax repository manager 206 provides services that facilitate the storage into and retrieval of data from the record repository 220. These services may be used by the tax determination manager 217 and tax administration manager 222.

Geography model 210 contains information about the geographical boundaries of the various jurisdictions associated with different tax regimes.

Tax configuration manager 218 provides services that can provide information from and/or can write information into, the geography model, the Trading Community Model, an inventory system, tax services request manager 202, tax determination manager 217, tax rules navigator 212 and tax administration manager 222.

Tax rules navigator 212 facilitates access to tax data contained in knowledge base 214 and tax rules contained in rule base 216. Note that knowledge base 214 and tax rules 216 may actually reside within database 134 illustrated in FIG. 1.

### Taxable Basis Implementation

The taxable basis is the base amount on which the tax is applied. Embodiments of the present invention determine the taxable basis amount for a tax in the context of the transaction. For each applicable tax, embodiments of the present invention determine the taxable basis using a taxable basis formula. A taxable basis formula for a given tax in the context of the transaction, when evaluated, will yield the taxable amount (also called taxable basis herein). A taxable basis formula may include one or more of the following:
The taxable basis type—whether it is Line Amount, Prior Tax, Assessable Value, or Quantity;
If the taxable basis type is Quantity, then the present invention does not apply to it;
If the taxable basis type is Line Amount or Prior Tax, then, the taxable basis formula should include a list of (non-empty) list of compounding taxes;
If the taxable basis type is Line Amount, whether a Base Rate Modifier needs to be applied to the Line Amount and, if so, the proper or improper fraction by which it ought to be modified. For example on a line amount of $100, a fraction of 0.75 implies that the only 75% of the line amount, i.e., $75 needs to be considered (in addition to the rest of the factors listed herein). Similarly, a Base Rate Modifier of 1.5 (an improper fraction) implies that $150 needs to be used instead of $100 in the example above.
Other factors such as discounts and/or charges that should be applied;
Whether the current tax is to be computed inclusive;

The taxable basis formula to be used may be determined by evaluating taxable basis formula determination rules (though not necessarily) for a given tax in the context of the transaction or the taxable basis formula to be used may be the default taxable basis formula specified for that tax. Embodiments of the present invention include derived taxable basis formulae for inclusive, exclusive taxes as well as compounded taxes and combinations thereof.

In Latin American countries, some taxes, such as the ICMS Tributary Substitution (Forward Substitution) need to consider a “planned margin” so that the tax authority may collect taxes at the point of first sale, rather than at the point of sale to the end consumer. Particularly in cases of high volume/low value products, this scheme allows for better efficiency of collection. The tax authority makes a determination of an “expected selling price” at the final point. The difference between the first point sale price and the current sale price, expressed as a percentage, is called the “planned margin”. A base rate modifier may be used in taxable basis formula to increase or reduce the taxable basis amount and satisfy this requirement.

The base rate may vary based on various determining factors such as product fiscal classification, ship from/ship to location, product, etc. Embodiments of the present invention call for a user to specify a constant value for the base rate modifier in the formula. Therefore, in cases where there are different base rates based on different conditions, multiple formulae using different base rates may be required and a plurality of rules may be required, which will point to the different formulae based on different conditions.

### Inclusive, Exclusive Taxes

A transaction line amount may have the amount quoted as inclusive of tax. In such a case, to compute the taxable basis from the line amount with inclusive tax, the transaction line amount should be modified in such a way that the modified transaction line amount plus tax amount based on the modified transaction line amount (the adjusted line amount or ALA) equals the original line amount.

For example, if a transaction has a line amount of $100, which also includes a tax which has a tax rate of 10%, then the tax amount is derived as follows:

Line Amount=Modified line amount+tax amount

But:

Tax amount=Modified line amount*tax rate

Therefore:

$$\begin{matrix}Modified line amount = line amount / ( 1 + tax rate ) \\ = 100 / ( 1.10 ) \\ = 90.91 and tax amount \\ = modified line amount * tax rate \\ = 90.91 * 0.1 \\ = 9.09\end{matrix}$$

Hence, the modified line amount plus tax amount=90.91+9.09=100, which is the original line amount.

Using the same taxable basis formula, the Tax Determination Manager 217, must be able to calculate the taxable basis (and then the tax amount) whether the tax is exclusive or inclusive. This is necessary because, whether or not a tax is included in the transaction line amount cannot always be known when setting up the taxable basis formula.

### Special Handling of Inclusive Taxes in Certain Cases

While in a majority of cases, an inclusive tax is computed as described above, in some cases (e.g., Latin America), the taxable basis is not adjusted after evaluating inclusive taxes. For example, in the case of “standard” inclusive taxes, the standard formula used for taxable basis is (Line Amount)*(Tax Rate/1+Tax Rate). However, in Latin America (especially in Brazil) for inclusive taxes, the standard formula for taxable basis is just the line amount, though the tax is included in the transaction line amount. (Note, however, that this tax may also need to consider base rate modifiers, discounts, charges, compounding taxes, etc). So, in the case of some taxes in Latin America, the taxable basis is never directly dependent upon the tax rate, as is the case of “standard” inclusive taxes.

### Compound Taxes, Surcharges

A tax may be compounded by one or more taxes. In this case, the taxable basis of the compounded tax may be equal to the transaction line amount plus the tax amount of all the compounding taxes. For example, the ICMS tax is sometimes compounded by the IPI tax. If the transaction line amount is $1000 and IPI tax rate is 12%, then the IPI tax amount is calculated as 12% of $1000, which comes to $120. The taxable basis (the adjusted line amount) of ICMS is IPI plus the line amount, which is $1000+$120=$1120.

The compounded tax may be a surcharge (a tax on a tax). In this case, the taxable basis of the compounded tax is the tax amount of the compounding tax. For example, VAT Additional is a surcharge on VAT. If the transaction line amount is $1000 and VAT is 10% of the line amount, then VAT tax is calculated as 10% of $1000, which comes to $100. The taxable basis of VAT Additional is the tax amount of VAT, which is $100. And, if the tax rate for the VAT Additional tax is 15%, then the tax amount for this tax will be 15% or $100, which will be $15.

### Discounts, Charges

A transaction/transaction line may have discounts or charges associated therewith. Accordingly, the taxable basis in some cases may need to be adjusted for these discounts and/or charges. The discounts may include, for example, cash discounts, trade discounts, volume discounts and the like. The charges may include, for example, transfer charges, packing charges, shipping and handling charges and the like. The values of trade discounts, volume discounts, transfer charges, packing charges may be expressed as amounts or percentages. If the discounts are specified in percentages, these should be converted into amounts before applying an embodiment of the present inventions to the transaction.

The tax computation for a single transaction line may include the determination of one or more combinations of exclusive and inclusive taxes that are applicable for that transaction line. Each of such taxes could be a compounded tax, a surcharge or neither. For any such tax, one or more of the following may apply: one base rate modifier, zero or more discounts and zero or more charges. In such a case, embodiments of the present invention may include complex algorithm to determine the Adjusted Line Amount (ALA) based on inclusive tax amounts and the taxable basis for all the taxes based on adjusted line amount, as detailed hereunder.

### Assumptions

If one tax is compounded by another tax, the first tax cannot also be used to compound the second tax. For example, if tax A is compounded by tax B, then tax B cannot be compounded by tax A. Enabling tax B to be compounded by tax A would establish impermissible circular dependencies between the two taxes. To prevent circular dependencies, compounding precedence may be assigned to taxes and tax regimes.

A tax may be compounded by another tax belonging to a different tax regime or the same tax regime according to embodiments of the present inventions. When taxes are compounded within the tax same regime, a tax with a lower precedence cannot be compounded by a tax with a higher precedence

In certain embodiments of the present inventions, the user is called on to specify a tax regime compounding precedence when defining tax regimes. Compounding precedence may be set up across tax regimes, such that a tax belonging to a tax regime having higher regime precedence cannot be compounded by a tax belonging to a tax regime having a lower regime precedence. Taxes belonging to another tax regime can have the same compounding precedence. Embodiments of the present invention enable a user to restrict which taxes may be compounded. Indeed, a flag may be used during formula definition to restrict the taxes that can be compounded. If this flag is set to N, cross-regime compounding is disabled, meaning that taxes belonging to other tax regimes cannot be used in the formula. Taxes in a regime having a lower precedence, according to embodiments of the present invention, cannot be compounded by taxes from a regime having higher precedence.

The compounding precedence of taxes may be visualized in a matrix format, as shown in the exemplary compound taxes shown in Table 2 below:

TABLE 2

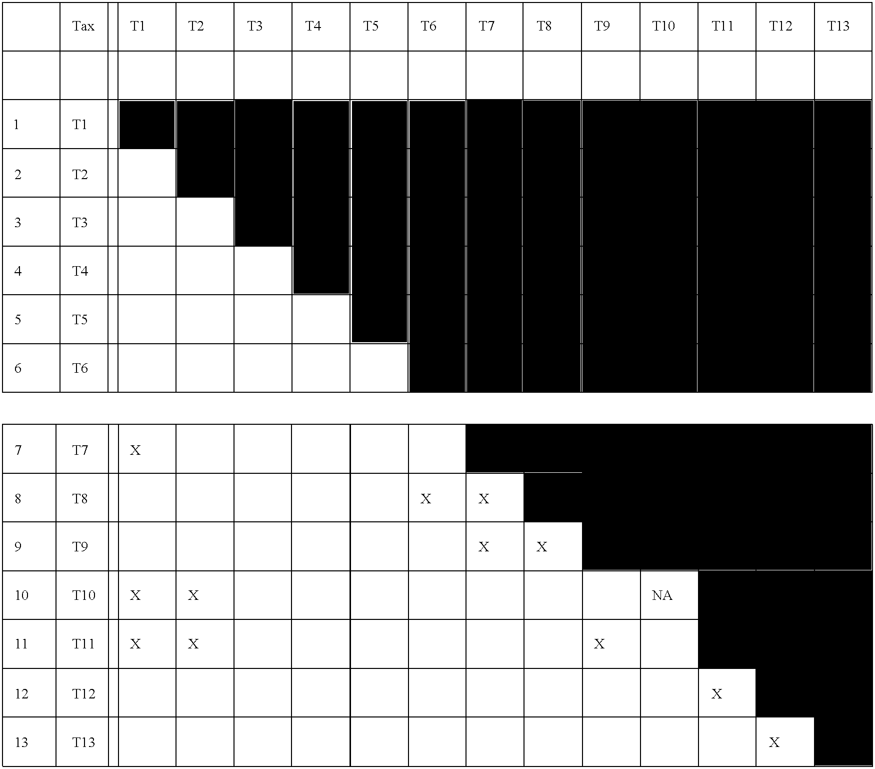

As shown in Table 2, compounding taxes are specified for taxes down the rows. Each compounding tax is marked with an “X”. In the example shown in Table 2, there are thirteen taxes, T1, T2 . . . T13. As shown by the “X”, tax T7 is compounded by tax T1. Tax T8 is compounded by taxes T6 and T7. Tax T9 is compounded by taxes T7 and T8. Tax T10 is compounded by taxes T1 and T2, tax T11 is compounded by taxes T1, T2 and T9, and tax T12 is compounded by T11. Lastly, tax T13 is compounded by tax T12. Note that in Table 2, the 13 taxes T1, T2 . . . T13 shown as an example may belong to the same tax regime or may span multiple tax regimes. In this table, it is assumed that any restrictions have been taken into account before the compounding for a given tax is specified.

Note that a tax cannot be compounded by itself, or by a tax having a higher precedence number, as indicated by the shaded boxes. Taxes with a lower precedence number, for example tax T1, cannot be compounded by a tax with a higher precedence number such as, for example, tax T7. Hence, the upper triangle in the above table is shaded and annotated with “NA”, indicating “Not Applicable.” A tax can only be compounded by another tax belonging to (and applicable to) the same transaction line. A tax in Transaction line 1 cannot be compounded by tax on transaction line 2. In the case of compounded taxes, the compounding tax should be calculated (and also rounded) before the tax calculation of the compounded tax starts, which impacts the manner in which tax calculation processes are sequenced. When a user overrides the tax status, the tax rate or the tax amount of an inclusive or compounded tax, all other taxes may (also need to be recalculated.

### Defining Determining Factors for Taxable Basis Calculation

The determining factors that may be used in taxable basis calculation may be (but not need not necessarily be) specified in an entity (e.g., a database table) called, for example, FORMULA within, for example, the database 132. Formulas may be configured for either taxable basis determination or tax calculation. The entity FORMULA may store the parameters that affect taxable basis determination and another entity (e.g., a database table) called, for example, FORMULA_DETAILS may store details of compounding taxes in, for example, the database 134. A user interface may be configured to enable the user to specify the following parameters for taxable basis determination. Representative determining factors for taxable basis computation may include, for example:

Tax/Tax Regime: The user may specify a tax and/or tax regime for which the formula is being defined. This information will be used to allow the user to select only taxes that have lower compounding precedence or taxes from regimes, which have lower regime compounding precedence in the formula details.

Formula Type: The formula type may be a tax calculation or taxable basis determination.

Taxable Basis Type: The user may select the following from a list of values (LOV): Line Amount, Prior Tax, Assessable Value or Quantity.

Enable/Disable: Each formula may be associated with an enable/disable flag, which may be set or reset to enable or disable a particular formula.

If compounding details need to be entered for the formula, both the tax and the tax regime may need to be specified to fully qualify the tax. When the Taxable basis type is ‘Line Amount’, and the formula type is taxable basis determination, the user may enter a percentage or fraction for the Base Rate Modifier and/or select one or more of the following determining factors, specifying for each selected whether it needs to be added to or subtracted from the line amount (or adjusted line amount) in the course of deriving the taxable basis:

Volume Discount;

Trade discount;

Cash Discount;

Other Discount;

Transfer Charge;

Transportation Charge;

Insurance Charge, and

Other Charge

When the taxable basis type is prior tax, (i.e., the current tax is a surcharge or tax-on-tax), the determining factors, base rate modifier, discounts and charges may not be selected. The implication of this is that discounts or base rate modifier may not be used along with prior taxes. However, the compounding taxes (stored in the FORMULA_DETAILS entity) may be specified for taxable basis type of line amount or prior tax. The formula details, which may be user-specified when the formula type is tax calculation, may be stored in the entity FORMULA_DETAILS. There are no limits on the number of compounding taxes that may be specified in the formula details.

The details for the compounding taxes may include for each compounding tax:

Compounding Tax;

Operator—(+, −, /, *), or

Constant value

The derived determining factors such as tax rate or taxable basis of another tax cannot be directly used as determining factors for tax calculation. The same formula should be usable by the Tax Determination Manager 217 to process a tax inclusively or exclusively.

When defining a tax, the default taxable basis formula/tax calculation may be (but not necessarily) allowed to be specified. Since many tax regimes use simple taxable basis formula of line amount, a taxable basis formula ‘STANDARD’ with the taxable basis type=‘line amount’ which does not have any discounts or charges or compounding taxes may be provided, as a pre-seeded taxable basis formula. Similarly, a tax calculation formula ‘STANDARD’ which is taxable amount*tax rate may also be seeded. A third formula called ‘QUANTITY’ with taxable basis type=‘quantity’ may also be seeded. These formulae may be generic and may not have tax/tax regime specified. Hence, such formulae may be used with any tax/tax Regime.

### Determining the Taxable Basis Formula

A determine taxable basis process may be (but not necessarily) defined and called to determine the taxable basis in the context of a transaction line. This process will perform taxable basis determination for all applicable tax lines for the current transaction line. The user may be provided with the ability to specify the parameters (determining factors) to be used by the aforementioned determine taxable basis process during the taxable basis calculation. These determining factors may be specified in the FORMULA entity and the compounding taxes may be specified in the FORMULA_DETAILS entity.

According to embodiments of the present invention, the determine taxable basis process (which may be carried out by or within the tax service 132, for example) attempts to obtain parameters for taxable basis calculation from two different sources, preferably in the following order:

1. The determine taxable basis process first tries to obtain parameters for taxable basis calculation by evaluating taxable basis determination rules, which may be user definable. The result type in the case of taxable basis determination is a taxable basis formula. The determining factors that may be used in the taxable basis formula may include only those determining factors whose data type is numeric.

2. The determine taxable basis process then tries to obtain parameters for taxable basis calculation from a default formula for the tax in question. This default formula may be used if, for example, the rule based evaluation above fails to provide a result or is a flag indicates that the default formula should be used.

This determine taxable basis process, according to embodiments of the present invention, may (but need not necessarily) evaluate taxable basis determination rules and/or use the default formula to obtain the parameters for taxable basis calculation. Once the determining factors are identified, this determine taxable basis process may, according to embodiments of the present invention, obtain values for the identified determining factors and store the obtained values in an array. For compounding taxes, the determine taxable basis process may create an array and store therein the compounding relationships for the current tax, together with other applicable taxes.

### Using the Taxable Basis Formula to Determine the Taxable Basis

According to embodiments of the present invention, the taxable basis formula may provide, for the current tax for the current transaction line, details including:

The taxable basis type—whether it is Line Amount, Prior Tax, Assessable Value, or Quantity;

If the taxable basis type is Line Amount or Prior Tax, then, the taxable basis formula should include a list of (non-empty) list of compounding taxes, and

If the taxable basis type is Line Amount, whether a Base Rate Modifier needs to be applied to the Line Amount and, if so, the proper or improper fraction by which it ought to be modified.

Other factors such as discounts and/or charges that should be applied may include whether the current tax is to be computed inclusive;

Once the parameters for taxable basis calculation and the tax inclusive flag are known, the logic specified in the following section may be used to determine taxable basis amount.

### Implementation of Taxable Basis Determination Algorithm

Overview

The presence of an inclusive tax most often alters the taxable basis to something different from the line amount itself. Note, however, that in some Latin American countries, the taxable basis is not adjusted after evaluating inclusive taxes. For example, if the line amount is 100 and the line amount includes a tax with a tax rate of 10%, the amount on which the tax rate is actually applied becomes:

$$\frac{100}{( 1 + Tax Rate )} = \frac{100}{1 + 10 / 100} = 90.9090909$$

This amount of 90.9090909 is the ALA, the “Adjusted Line Amount” on which the tax rate is applied. If a tax rate of, for example, 10% is applied to this ALA, it yields a tax amount of 9.090909091. Adding the tax amount to the Adjusted Line Amount, we get (9.090909091+90.9090909), which equals 100, the original line amount. In other words, we can say:

Line Amount=Adjusted Line Amount+Included Tax

Which can be stated as:

Line Amount=Adjusted Line Amount+Adjusted Line Amount*Tax Rate.

This can, in turn, be restated as follows:

Line Amount=Adjusted Line Amount(1+Tax Rate)

### Specific Implementations

Determining the Taxable Basis when There are Two Included Taxes

In this determination, we assume (as an example) that there are two inclusive taxes, a first inclusive tax of 10% and a second inclusive tax of 5%. In this case, the ALA may be determined by the tax service 132 in such a way that when the two tax rates are applied and the two tax amounts are derived, and added to the ALA, the sum yields the line amount itself. In other words:

Line Amount=Adjusted Line Amount+Tax Amount of 10% tax+Tax Amount of 5% tax

This is equivalent to saying:

Line Amount=Adjusted Line Amount+Adjusted Line Amount*10%+Adjusted Line Amount*5%

Which can be restated as follows:

Line Amount=Adjusted Line Amount(1+10%+5%)

Note that, in the above equation, the line amount and the first and second inclusive tax rates are known. The ALA, however, needs to be determined. The taxable basis formula, then, may be stated as follows:

$$A L A = \frac{L}{( 1 + Tax {Rate}_{1} + Tax {Rate}_{2} )}$$

where

ALA is the Adjusted Line Amount;

L is the Line Amount, and

Tax Rate₁ is 10% and Tax Rate₂ is 5%.

Using the rates in this example, the ALA may be derived as follows:

$$A L A = \frac{100}{( 1 + 0.10 + 0.05 )} = 86.95652174$$

Applying the result and computing the tax amounts for the two taxes, we have:

| | | | |
|---|---|---|---|
| Tax 1 10% | | 8.695652174 | (10% of 86.95652174) |
| Tax 2 5% | | 4.347826087 | (5% of 86.95652174) |
| ALA | + | 86.95652174 | |
| Total: | | 100.00000000 | |

Therefore, the line amount of 100 is equal to the ALA of 86.95652174 plus the Tax₁ amount of 8.695652174 plus the Tax₂ amount of 4.347826087, as required.

Determining the Taxable Basis with Two Included Taxes with Compounding

Now, consider the case wherein a first tax (Tax Rate₁) is compounded by a second tax (Tax Rate₂). That is, the tax rate Tax Rate₂ is to be applied not only on the ALA, but is to be applied on the sum of the ALA and the Tax Amount₁ (computed at the rate of) Tax Rate₁.

Therefore, the Tax Rate₂ is to be applied on (ALA+ALA*Tax Rate₁)

In other words, Tax Amount₂=ALA*(1+Tax Rate₁)*Tax Rate₂

Thus:

L=ALA+ALA*Tax Rate₁+ALA*(1+Tax Rate₁)*Tax Rate₂

Factoring, this yields:

L=ALA(1+Tax Rate₁+(1+Tax Rate₁)*Tax Rate₂)

Again, it can be seen that the ALA (the taxable basis amount) can be derived based on the Line Amount (L) and the tax rates, using the taxable basis formula below:

$$A L A = \frac{L}{( 1 + Tax {Rate}_{1} + ( 1 + Tax {Rate}_{1} ) * Tax {Rate}_{2} )}$$

Applying the above formula to the example above, the ALA works out to:

$$\begin{matrix}= \frac{100}{( 1 + 0.10 + ( 1 + 0.10 ) * 0.05 )} \\ = \frac{100}{( 1 + 0.10 + 0.055 )} \\ A L A = 86.85008658\end{matrix}$$

This results may be verified by computing the inclusive tax amounts and adding the tax amounts to the ALA to ensure that the sum thereof adds up to the original line amount of 100:

| | | | |
|---|---|---|---|
| Tax 1 10% | | 8.658008658 | (10% of 86.58008658) |
| Tax 2 5% | | 4.761904762 | (5% of (86.58008658 + |
| | | | 8.658008658) = 5% |
| | | | of (95.238095238)) |
| ALA | + | 86.58008658 | |
| Total: | | 100.00000000 | |

Determining the Taxable Basis with One Exclusive Tax, Two Included Taxes, with Compounding of Included Taxes

The example developed below assumes that, in addition to two included taxes (one of which needs to be compounded), there is another exclusive tax. In summary:

Tax₀ is an exclusive tax, with a tax rate of, for example, 15%;

Tax₁ is an included tax, with a tax rate of, for example, 10%;

Tax₂ is an included tax, with a tax rate of, for example, 5%. Tax₂ tax is to be compounded with Tax₁. The line amount (L) is, as in the examples developed above, 100.

By definition, since the Line Amount only includes inclusive taxes, the following can be said to be true:

L=ALA+ALA*Tax Rate₁+ALA*(1+Tax Rate₁)*Tax Rate₂

And:

Tax Amount₀=ALA*Tax Rate₀, where Tax Amount₀ is the tax amount for the exclusive tax, Tax₀.

It can be seen that an exclusive tax does not affect the computation of the ALA or the inclusive taxes. Therefore, the ALA and the tax amounts for taxes Tax₁ and Tax₂ are the same as in the previous example. The tax amount for Tax₀ is, therefore, 15% of 86.58008658, or 12.98701299.

One Exclusive Tax, Two Included Taxes with Compounding of Both Exclusive and Included Taxes

In this scenario, all parameters remain the same as above, except that the exclusive tax Tax₀ is used for compounding tax Tax₁. In summary:

Tax₀ is an exclusive tax, with a tax rate of, say 15%;

Tax₁ is an included tax, with a tax rate of 10%, and is computed by compounding tax Tax₀;

Tax₂ is an included tax, with a tax rate of 5%. This tax needs to be compounded with Tax₁, and

The line Amount (L) is 100.

By definition, though the Line Amount still only includes inclusive tax amounts, the compounded exclusive tax amount will have an effect on the ALA. Let us start with the basic equation:

L=ALA+Tax Amount₁+Tax Amount₂

Since Tax₁ is computed by compounding tax Tax₀, we can say:

$$\begin{matrix}Tax {Amount}_{1} = ( A L A + Tax {Amount}_{0} ) * Tax {Rate}_{1} \\ = ( A L A + A L A * Tax {Rate}_{0} ) * Tax {Rate}_{1} \\ = A L A * ( 1 + Tax {Rate}_{0} ) * Tax {Rate}_{1}\end{matrix}$$

And, since Tax₂ is computed by compounding tax Tax₁, we can say:

$$\begin{matrix}Tax {Amount}_{2} = ( A L A + Tax {Amount}_{1} ) * Tax {Rate}_{2} \\ = ( A L A + A L A * ( 1 + Tax {Rate}_{0} ) * Tax {Rate}_{1} ) ) * Tax {Rate}_{2}\end{matrix}$$

The elements in bold type are substituted from the equation for Tax Amount1, developed above. The expression for Tax Amount2 can be simplified further to:

Tax Amount₂=ALA*(1+(1+Tax Rate₀)*Tax Rate₁)*Tax Rate₂

Substituting the expressions for Tax Amount₁ and Tax Amount₂ in the equation for the Line Amount, L, we have:

L=ALA

+ALA*(1+Tax Rate₀)*Tax Rate₁

+ALA*(1+(1+Tax Rate₀)*Tax Rate₁)*Tax Rate₂

The line amount L may be further simplified (by making use of ALA as a common factor) to:

L=ALA[1+(1+Tax Rate₀)*Tax Rate₁+(1+(1+Tax Rate₀)*Tax Rate₁)*Tax Rate₂]

The line amount L may be simplified yet again (by taking out the bold part in the above equation as the common factor) to yield:

L=ALA*(1+(1+Tax Rate₀)*Tax Rate₁)*[1+Tax Rate₂]

Therefore, the taxable basis formula may be stated as follows:

$$A L A = \frac{L}{( 1 + ( 1 + Tax {Rate}_{0} ) * Tax {Rate}_{1} ) * [ 1 + Tax {Rate}_{2} ]}$$

Substituting the values in the example, we have:

$$\begin{matrix}A L A = \frac{100}{( 1 + ( 1 + 0.15 ) * 0.1 ) * [ 1 + 0.05 ]} \\ = \frac{100}{( 1 + 0.115 ) * [ 1.05 ]} \\ = 85.415332050\end{matrix}$$

The computed value of the ALA may be verified the results by computing the inclusive tax amounts and adding the tax amounts to the ALA to ensure that it equals the Line Amount (100).

| Exclusive Tax: | | |
|---|---|---|
| Tax 0 15% | 12.81229981 | 15% of 85.415332050 |
| Inclusive Taxes: | | |
| Tax 1 10% | 9.822763186 | (10% of (85.415332050 + |
| | | 12.81229981) = 10% |
| | | of (98.22763186)) |
| Tax 2 5% | 4.761904762 | (5% of (85.415332050 + |
| | | 9.822763186) = 5% |
| | | of (95.23809524)) |
| ALA | 85.415332050 | |
| Total: | 100.000000000 | |

Therefore, when Tax₀, the tax amount from Tax₁ and the tax amount of Tax₂ are added to the computed ALA, the original line amount L is again generated, meaning that the taxes and the ALA were correctly computed.

One Exclusive Tax, Two Included Taxes, One Surcharge—with Compounding of Both Exclusive and Included Taxes

In this scenario, all parameters remain the same as above with the exception that the exclusive tax is used for compounding tax Tax₁. In summary:

Tax₀ is an exclusive tax, with a tax rate of, say 15%;

Tax₁ is an included tax, with a tax rate of 10%, and is computed by compounding tax Tax₀;

Tax₂ is an included tax, with a tax rate of 5%. This tax is to be compounded with Tax₁;

Tax₃ is an included tax, with a tax rate of 15%. This tax is a surcharge of Tax₂. (That is, Tax₃ is computed as a “tax-on-tax” on the tax amount of Tax₂, and

The line amount (L) remains 100.

By definition, though the Line Amount still only includes inclusive tax amounts, the compounded exclusive tax amount will have an effect on the ALA. Let us start with the basic equation:

L=ALA+Tax Amount1+Tax Amount2+Tax Amount3

From the previous section:

Tax Amount1=ALA*(1+Tax Rate₀)*Tax Rate₁

Tax Amount2=ALA*(1+(1+Tax Rate₀)*Tax Rate₁)*Tax Rate₂

Since Tax₃ is a surcharge of Tax₂, we can derive the value for Tax Amount2 as follows:

Tax Amount3=Tax Amount2*Tax Rate₃

Substituting the expressions for Tax Amount2, we have:

$$\begin{matrix}Tax Amount 3 = [ A L A * ( 1 + ( 1 + Tax {Rate}_{0} ) * Tax {Rate}_{1} ) * \\ Tax {Rate}_{2} ] * Tax {Rate}_{3} \\ = A L A * ( 1 + ( 1 + Tax {Rate}_{0} ) * Tax {Rate}_{1} ) * \\ Tax {Rate}_{2} ) * Tax {Rate}_{3}\end{matrix}$$

Substituting the expressions for Tax Amount1, Tax Amount2 and Tax Amount3 in the equation for the Line Amount, L, we have:

L=ALA

+ALA*(1+Tax Rate₀)*Tax Rate₁

+ALA*(1+(1+Tax Rate₀)*Tax Rate₁)*Tax Rate₂

+ALA*(1+(1+Tax Rate₀)*Tax Rate₁)*Tax Rate₂]*Tax Rate₃

This expression may be further simplified (by making use of ALA as a common factor) to:

$$\begin{matrix}L = A L A * [ 1 + ( 1 + Tax {Rate}_{0} ) * Tax {Rate}_{1} + \\ ( 1 + ( 1 + Tax {Rate}_{0} ) * Tax {Rate}_{1} ) * Tax {Rate}_{2} + \\ ( 1 + ( 1 + Tax {Rate}_{0} ) * Tax {Rate}_{1} ) * Tax {Rate}_{2} ) * Tax {Rate}_{3} ] \\ = A L A * [ 1 + ( 1 + Tax {Rate}_{0} ) * Tax {Rate}_{1} ] \\ ( 1 + Tax {Rate}_{2} + Tax {Rate}_{2} * Tax {Rate}_{3} ) \\ = A L A * [ 1 + ( 1 + Tax {Rate}_{0} ) * Tax {Rate}_{1} ] \\ ( 1 + Tax {Rate}_{2} * ( 1 + Tax {Rate}_{3} ) )\end{matrix}$$

Therefore, we have the following taxable basis formula:

$$A L A = \frac{L}{\begin{matrix}[ 1 + ( 1 + Tax {Rate}_{0} ) * Tax {Rate}_{1} ] \\ ( 1 + Tax {Rate}_{2} * ( 1 + Tax {Rate}_{3} ) )\end{matrix}}$$

Substituting the values in the example, we have:

$$\begin{matrix}A L A = \frac{100}{[ 1 + ( 1 + 0.15 ) * 0.1 ] ( 1 + 0.05 * ( 1 + 0.15 ) )} \\ = \frac{100}{[ 1 + ( 1.15 ) * 0.1 ] ( 1 + 0.05 * ( 1.15 ) )} \\ = \frac{100}{[ 1.115 ] ( 1.0575 )} \\ = 84.80954956\end{matrix}$$

We can verify the results again by computing the inclusive tax amounts and adding the tax amounts to the ALA to verify that it equals the Line Amount (100).

| Exclusive Tax: | | | |
|---|---|---|---|
| Tax 0 15% | | 12.72143243 | 15% of 84.80954956 |
| Inclusive Taxes | | | |
| Tax 0 10% | | 9.753098199 | (10% of (84.80954956 + |
| | | | 12.72143243) = 10% |
| | | | of 97.53098199) |
| Tax 2 5% | | 4.728132388 | (5% of (84.80954956 + |
| | | | 9.753098199) = 5% |
| | | | of 94.562647759) |
| Tax 3 15% | | 0.709219858 | (15% of 4.728132388) |
| ALA | + | 84.809549560 | |
| Total: | | 100.000000000 | |

In all the scenarios that have been considered, it is seen that the ALA can be determined by knowing the Line Amount and the Tax Rates of each of the taxes applicable. To explain this further, consider the equation for ALA in the scenario in which there are two included taxes, and Tax₁ is compounded by Tax₂:

$$A L A = \frac{L}{( 1 + Tax {Rate}_{1} + ( 1 + Tax {Rate}_{1} ) * Tax {Rate}_{2} )}$$

For the purpose of analysis, let us consider just the denominator of the right hand side of the above equation, i.e. the part of the above equation in bold print:

1+Tax Rate₁+(1+Tax Rate₁)*Tax Rate₂)

This can be expanded as follows:

1+Tax Rate₁+Tax Rate₂+Tax Rate₁*Tax Rate₂

In the above expression, the bolded portion of the expression is the “contribution to the ALA” of the tax rates of the two taxes, Tax₁ and Tax₂. In other words, we can say that:

Contribution from Taxes to ALA=Tax Rate₁+Tax Rate₂+Tax Rate₁*Tax Rate₂

There are 3 components in the expression above:

| Component | Contribution to ALA From |
|---|---|
| Tax Rate₁ | Tax₁ |
| Tax Rate₂ | Tax₂ |
| Tax Rate₁*Tax Rate₂ | Tax₁ and Tax₂ |

Let us populate the values for the tax rates as follows:
Tax₁ is an included tax, with a tax rate of 10%.
Tax₂ is an included tax, with a tax rate of 10%. This tax is to be compounded with Tax₁.

| | | Calculated |
|---|---|---|
| Component | Values | Values |
| Tax Rate₁ | 0.1 | 0.100 |
| Tax Rate₂ | 0.05 | 0.050 |
| Tax Rate₁*Tax Rate₂ | 0.1*0.05 | 0.005 |
| Sum | | 0.155 |

The above table can be re-written as follows:

| | Contribution | Contribution | |
|---|---|---|---|
| Component | from Tax₁ | from Tax₂ | Sum |
| Tax₁ | 0.1 | — | 0.100 |
| Tax₂ | 0.05 * 0.1 | 0.05 | 0.055 |
| Sum | | | 0.155 |

The sum in the table above is the result of applying values of the example in the expression:

Tax Rate₁+Tax Rate₂+Tax Rate₁*Tax Rate₂

Now, going back to the expression for ALA

$$\begin{matrix}A L A = \frac{L}{( 1 + Tax {Rate}_{1} + ( 1 + Tax {Rate}_{1} ) * Tax {Rate}_{2} )} \\ = \frac{L}{1 + Tax {Rate}_{1} + Tax {Rate}_{2} + Tax {Rate}_{1} * Tax {Rate}_{2}} \\ = \frac{L}{1 + ( Contributions from taxes to ALA )} \\ = \frac{L}{1 + 0.155}\end{matrix}$$

Substituting the value for L as 100, we get:

$$A L A = \frac{100}{1 + 0.155} = 86.58008658$$

Multiplying the ALA with the tax rates and summing up, we can verify that it adds up to the line amount of 100:

| | | | |
|---|---|---|---|
| Tax 1 10% | | 8.6580088 | (10% of 86.58008658) |
| Tax 2 5% | | 4.7619042 | (5% of (86.58008658 + |
| | | | 8.658008658) = 5% |
| | | | of 95.238095238) |
| ALA: | + | 86.580088 | |
| Total: | | 100.00000 | |

Therefore, in general, we can say that the adjusted line amount works out to the following taxable basis formula:

$$A L A = \frac{L}{1 + ( Contributions from Inclusive taxes to A L A )}$$

Using this result, we can write down the example of the one exclusive tax, and three inclusive taxes one of which is a surcharge. In summary:
Tax₀ is an exclusive tax, with a tax rate of, say 15%;
Tax₁ is an included tax, with a tax rate of, for example, 10%, and is computed by compounding tax Tax₀;
Tax₂ is an included tax, with a tax rate of, for example, 5%. This tax is to be compounded with Tax₁;
Tax₃ is an included tax, with a tax rate of, for example, 15%. This tax is a surcharge of Tax₂. That is, Tax₃ is computed as a “tax-on-tax” on the tax amount of Tax₂.
The Line Amount (L) is 100.

In Table 3 below, T0 refers to Tax₀ and so on. Further, for the row of a given tax, say T1, an X under tax T0 indicates that tax T0 is needed for compounding tax T1. An “S” for a given row indicates that it is a surcharge or a tax-on-tax. For example, for the row of tax T3, there is an “S” under the column of tax T2. This means that tax T3 is a surcharge of tax T2. Also, in the column “Inclusive?”, a value of “Y” indicates that that tax of that row is included in the line amount. The column “Compounding Precedence” indicates the order in which taxes are processed, which also indicates which taxes may be used for compounding. For example, in the table below, no tax may be compounded for the tax with the compounding precedence of 1—i.e., T0. Tax T2 may not be used for compounding tax T1 as it is lower in precedence. Also, a tax cannot be compounded on or by itself. Accordingly, in the “Compounded by” columns, all the disallowed compounding situations are marked with a “-”. Allowed compounding that is not used is left blank.

TABLE 3

| | | | | | | | | Contributions | | Un-rounded Tax |
|---|---|---|---|---|---|---|---|---|---|---|
| | | | | | | | | to ALA | Adjusted Line | Amounts |
| Compounding | | Tax | Compounded by | | | | | (Inclusive taxes | Amount (ALA) | (ALA * Tax |
| Precedence | Tax | Rate | T0 | T1 | T2 | T3 | Inclusive? | only) | Computation | Rate) |
| 1234 | T0T1T2T3 | 15%10% 5%15% | —X | ——X | ———S | ———— | NYYY | — 0.115 0.05575+0.0083625 0.1791125 | $\frac{100}{( 1 + 0.1791125 )} = 84.80954956$ | 12.72143243 9.753098199 4.728132388 0.709219858 |

Extension of the Above Concepts to Other Determinants of Taxable Basis

In the preceding sections, it has been demonstrated that the following scenarios can be handled simply by considering the tax rates of the various taxes:

Multiple inclusive taxes;

Exclusive taxes;

Compounding of one inclusive tax for another inclusive tax;

Compounding of one exclusive tax for an inclusive tax;

Calculation of one inclusive tax on another inclusive tax amount (i.e., tax-on-tax);

Combinations of the above cases

All the above scenarios were handled, according to embodiments of the present invention, by treating tax rates as “multipliers” appropriately applied in order to determine the Adjusted Line Amount (ALA). Once the ALA has been determined, it is a matter of multiplying the ALA with the tax rates to arrive at the tax amounts.

It is not readily apparent, however, that for cases where the taxable basis is not based off of the line amount, this approach can be employed. In particular, when non-unity base rate modifiers (i.e., base rate modifiers that are not exactly equal to 1) are involved and/or when one or more charges are to be added and/or when one or more discounts are to be subtracted, it is not readily apparent that the approach can be utilized. However, according to embodiments of the present invention, all such factors may be reduced to multipliers that may readily be processed in a system such as Tax Service 132. It is to be noted that other implementations, if possible, would be prohibitively expensive to build and/or maintain.

In a similar fashion and according to further embodiments of the present invention, the following determining factors that affect the taxable basis may also be converted, according to embodiments of the present invention, to multipliers that yield the desired result:
Base Rate Modifier: For example, a base rate modifier of +100% implies that the base on which the tax must be computed is Line Amount*(1+100%)=Line amount*2. We can therefore consider 2 as the multiplier for this case. Thus, the “Base Rate Modifier Multiplier” can be said to be:

$$( 1 + \frac{Base Rate Modifier \%}{100} )$$

Volume Discount Say that there is a volume discount of 20% and the taxable basis is allowed to be reduced by the volume discount. Therefore, if the line amount were 100, then the Volume Discount would be 20 and the taxable basis would be 80.
Trade Discount Handled in the same manner as volume discount;
Cash Discount Handled in the same manner as volume discount;
Other Discount Handled in the same manner as volume discount;
Transfer Charge Handled in the same manner as volume discount;
Transportation Charge Handled in the same manner as volume discount;
Insurance Charge Handled in the same manner as volume discount;
Other Charges Handled in the same manner as volume discount;

As an example, consider that there is a base rate modifier of +100% and a volume discount of 20% and both apply for a given tax, and the line amount is 100. The tax rate is then applied on: (100−20)*2=160. If the tax rate were 10%, the tax amount would be 16.

### Multiple Discounts and Charges

According to further embodiments thereof, the present invention handles cases in which there is more than one discount such as, for example, a volume discount and a trade discount. In this case, the line amount L should be reduced by both the volume and trade discounts:

Line Amount−Volume Discount−Trade Discount.

Similarly, if there were other discounts or charges, we would need to consider:

Line Amount−Volume Discount−Trade Discount−Other Discount+Transportation Charge+ . . .

Or, we could say:

Line Amount Adjusted for Discounts and Charges=Line Amount−(Sum of Discounts−Sum of Charges)

Factoring out Line Amount, the above expression may be re-written as:

Line Amount Adjusted for Discounts and Charges=

$$Line Amount ( 1 - ( \frac{Sum of Discounts - Sum of Charges}{Line Amount} ) )$$

In the example above—i.e., Volume Discount of 20% and a line amount of 100, the line amount adjusted for discounts and charges is:

$$Line Amount Adj . for Discounts and Charges = 100 * ( 1 - ( \frac{20}{100} ) ) = 100 * 0.8 = 80$$

Let us add a trade discount of 5%. Then:

$$Line Amount Adj . for Discounts and Charges = 100 * ( 1 - ( \frac{20 + 5}{100} ) ) = 100 * 0.75 = 75.$$

Thus, the Line Amount Adjusted for Discounts and Charges can be expressed as follows:

Line Amount Adjusted for Discounts and Charges=Line Amount*Net Discounts and/or Charges Multiplier,

where:

$$Net Discounts and \text{/} or Charges Multiplier = 1 - ( \frac{Sum of Discounts - Sum of Charges}{Line Amount} )$$

Putting together the effect of both the base rate modifier and charges and discounts, we can say that:

Line Amount Adjusted for Base Rate Modifier and Charges and Discounts=Line Amount*Base Rate Modifier multiplier*Net Discounts and/or Charges Multiplier

Just as the effects of both base rate modifiers and charges and discounts can be reduced to a multiplier each, a “Net Multiplier” may be defined, according to further embodiments of the present invention, as:

Net Multiplier=Base Rate Modifier multiplier*Net Discounts and/or Charges Multiplier

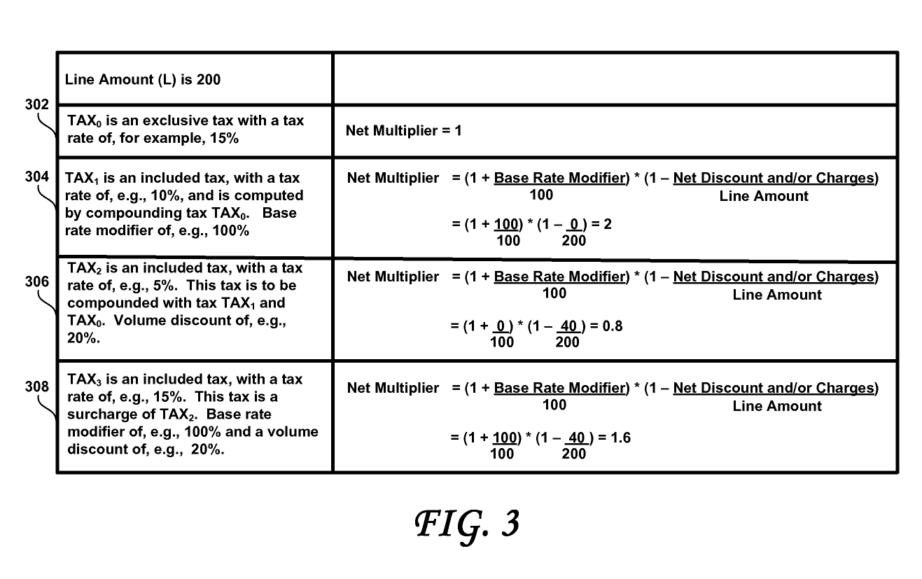

FIG. 3 shows examples of the computation and use of the Net Multiplier according to embodiments of the present invention. As shown, the first example 302 shows the case of a single exclusive tax, in which case the net multiplier is 1. The second example 304 uses an included tax, a compounding tax and a base rate modifier. The third example 306 illustrates the case wherein a first tax is compounded with two other taxes and in which a volume discount of 20% has been granted. FIG. 3 also shows a fourth example 308 to illustrate the net multiplier. In this example, an included tax is a surcharge of another tax, there is a base rate modifier of, e.g., 100% and a volume discount of 20%.

The values for the net multiplier may now be used to derive the tax amounts, for the example detailed in Table 3 above, as shown in Table 4 immediately below:

TABLE 4

| | | | | | | | | | Contributions to | Adjusted Line | Un-rounded Tax |
|---|---|---|---|---|---|---|---|---|---|---|---|
| Compounding | | Tax | Net | Compounded by | | | | | ALA (Inclusive | Amount (ALA) | Amounts |
| Precedence | Tax | Rate | Multiplier | T0 | T1 | T2 | T3 | Inclusive? | taxes only) | Computation | (ALA * Tax Rate) |
| 1234 | T0T1T2T3 | 15%10% 5%15% | 1.02.00.81.6 | —XX | ——X | ———S | ———— | NYYY | — 0.230000 0.055200+0.013248 0.298448 | $\frac{100}{( 1 + 0.298448 )} = 77.01502101$ | 11.55225315017.713454830 4.251229160 1.020294998 |

The values may be verified that summing up the inclusive tax amounts with the ALA yields 100. That is:

$$\begin{matrix}Tax {T}_{1} & = & 17.713454830 \\ Tax {T}_{2} & = & 4.251229160 \\ Tax {T}_{3} & = & 1.020294998 \\ A L A & = & + \underline{77.015021010} \\ Total & & 100.000000000\end{matrix}$$

### Special Handling of Latin American Inclusive Tax

In Latin America, inclusive taxes are handled in a special manner. For example, consider the ICMS tax in Brazil with, for example, a rate of 10% and a line amount of 100. In this case, the tax is 10 and not 90.9090909. This is handled by computing the tax amount based on the line amount itself, instead of the adjusted line amount.

For example, if L is the Line Amount and R is the tax rate, then, the

L=ALA(1+R) in the standard case.

In the special inclusive handling case, the ALA is derived as follows:

$$\begin{matrix}L = A L A + Tax Amount \\ = A L A + L * Tax Rate\end{matrix}$$

Therefore, ALA=L(1−Tax Rate)

This special handling may be carried out if a flag at the tax level indicates that the computation requires special inclusive handling instead of the standard inclusive handling.

### Development of Taxable Basis Formula

According to further embodiments of the present invention, the foregoing examples of inclusive, exclusive and compounded taxes may be further developed and expanded to include any number of inclusive, exclusive and compounded taxes, according to the taxable basis formulae developed hereunder. In the taxable basis formulae developed below, let:
Line Amount=L;
Adjusted Line Amount=X;
n taxes, i=1 . . . n;
d discounts, r=1 . . . d
c discounts, s=1 . . . c
For the i^{th} tax, Tᵢ:
   the base rate modifier=bᵢ;
   the tax rate=rᵢ, and
   the tax amount=Tᵢ (note that in equations, the tax amount for tax Tᵢ is indicated as Tᵢ itself).
The compounding relationship between one tax (i) and another (j) be represented by a “Compounding Matrix”, M, which is a n by n matrix, both ordered 1 to n in increasing compounding precedence numbers;
The Base Rate Modifier for is represented by a “Base Rate Modifier Matrix”, B, which is a n×1 matrix, ordered 1 to n in increasing compounding precedence numbers. Each value in the matrix indicates the percentage of the line amount that needs to be added (a positive number), subtracted (a negative number), or none (a 0 value);
Whether a given tax is a surcharge or not be represented by a “Inclusive Matrix”, N, which is a n×1 matrix ordered 1 to n in increasing compounding precedence numbers;
Whether a given tax is a surcharge or not be represented by a “Surcharge Matrix”, S, which is a n×1 matrix ordered 1 to n in increasing compounding precedence numbers;
Whether a given tax needs to consider a particular discount is represented by a matrix D, which is a n×d matrix. The rows are ordered 1 to n in increasing compounding precedence numbers, while columns are ordered 1 to d in any order of discounts, and
Whether a given tax needs to consider a particular charge is represented by a matrix C, which is a n×c matrix. Both ordered 1 to n in increasing compounding precedence numbers. The rows are ordered 1 to n in increasing compounding precedence numbers, while columns are ordered 1 to d in any order of charges.

The actual discounts expressed as a fraction of the line amount is represented by the list d₁, d₂, . . . d_{d}.

The actual charges expressed as a fraction of the line amount is represented by the list c₁, c₂, . . . c_{c}.

Presented below are the generalized derivations for various cases.

Consider the following matrices mentioned above.

Compounding Matrix, M

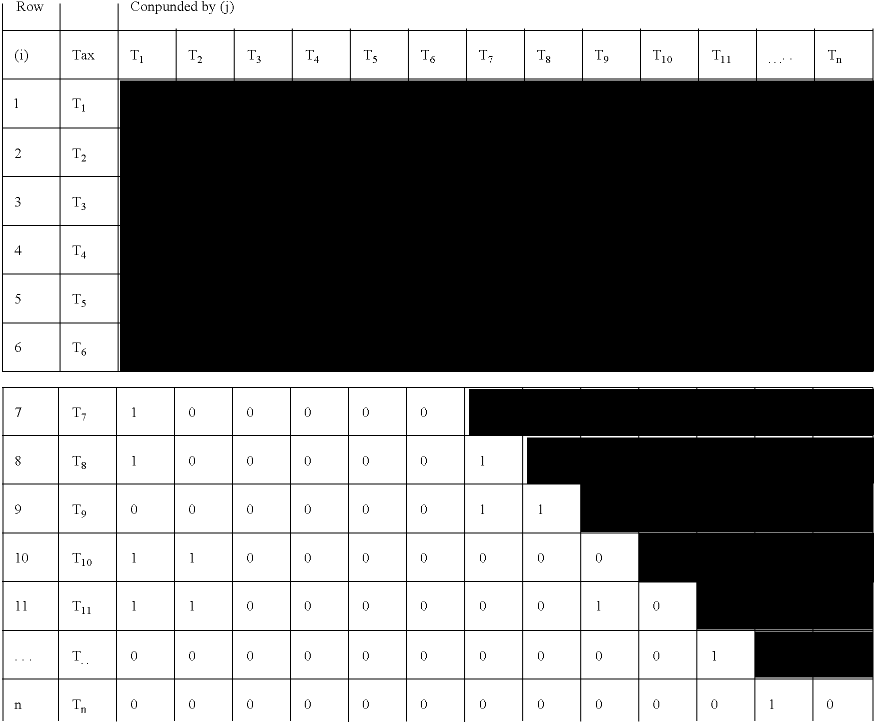

In the above matrix (M), the rows are represented by the subscript, “i” and the columns are represented by the subscript, “j”. With the convention that M_{1,2} represents the cell formed by the first row and which has a value of 0 in this case. Similarly, M_{10,9} represents the cell formed by the 10^{th} row and the 9^{th} column, which in the matrix above has a value of 1. The ellipses ( . . . ) indicates that this table can have any number of rows. In other words, since each row represents an applicable tax for a given transaction line, what this means is that this approach is sufficiently generic to handle any number of taxes. Hereunder, the subscript “n” represents the total number of taxes of all types—inclusive or exclusive, compounded or surcharges.

Note that some of the cells are grayed out and with a “0” value therein. This is because the tax indicated by the column is not compounded for the tax in that particular row. For example, the cell represented by row 7 and column 6 (or, in short hand, cell (7,6), used hereafter) has a value “0” in the matrix M above. What this means is that tax T₆ is not used for compounding to arrive at the tax amount for tax T₇. In other words, T₆ does not affect the taxable basis for T₇. On the other hand, cell (8,7) has a value of 1. This indicates that T₇ is used to compound T₈.

Note also that a tax with a higher compounding precedence number cannot be used to compound a tax with a lower compounding precedence number. Additionally, a tax cannot be used to compound itself. Thus, all cells along the main diagonal and above will, by definition, have a value of 0 in the compounding matrix, M. In other words, a cell (i, j) where i<=j (i is less than or equal to j) will have a value of 0.

With the above explanation in mind, the other matrices may be considered.

Base Rate Modifier Matrix, B

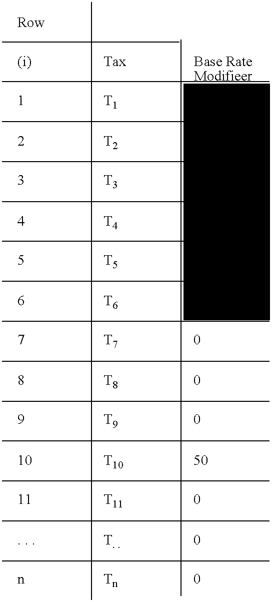

The surcharge matrix, N, has a value of 1, in a cell if the tax is inclusive. So, cell (6,1) has a value −25, indicating that for tax T6 25% of the line amount needs to subtracted, whereas cell (7,1) has a value 0 indicating that for tax T₇, no amount is to be added or subtracted from the line amount.

Inclusive Matrix, N

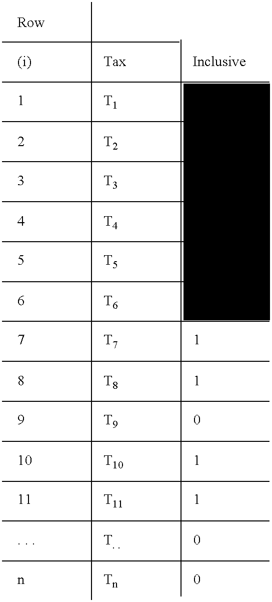

The surcharge matrix, N, has a value of 1, in a cell if the tax is inclusive. So, cell (6,1) has a value 0, indicating that tax T6 is not a inclusive, whereas cell (7,1) has a value 1 indicating that tax T₇ is a inclusive.

Surcharge Matrix, S

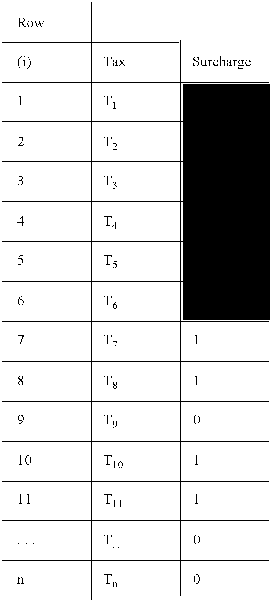

The surcharge matrix, S, has a value of 0, in a cell if the tax is a surcharge. So, cell (6,1) has a value 0, indicating that tax T6 is a surcharge, whereas cell (7,1) has a value 1 indicating that tax T₇ is not a surcharge.

Discount Applicability Matrix, D

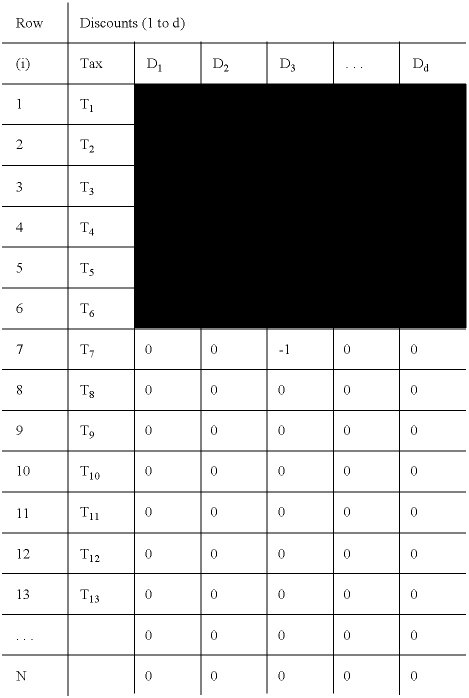

The discounts applicability matrix, D, is an n×d matrix, with as many rows as the number of applicable taxes for a transaction line and as many columns as the number of discounts that are available on the transaction line. A cell has a value of −1, in a cell if the discount (indicated by the column) is to be removed from the line amount in computing the taxable basis. So, cell (6,1) has a value 0, indicating that for tax T6 the discount D₁ is not to be considered, whereas cell (6,2) which has a value −1 indicating that for tax T₆ the discount D₂ needs to be subtracted from the line amount.

Charges Applicability Matrix, C

Charges applicability matrix, C, is identical to that described for the discounts applicability matrix, D, except that there will be a value of 1 when a charge needs to be added to the line amount.

### The Mathematical and Programmatic Model

Assuming the definitions above, the following equation applies:

L=X+ᵢ₋₁ΣₙIᵢ*Tᵢ Eqn. 1

(where the notation ᵢ₋₁Σⁿ indicates a summation where the index (or subscript) ranges from 1 to n.

In other words, the line amount less the sum of inclusive taxes, should be equal to the adjusted line amount. Note that the value of a cell in the Inclusive matrix, I is multiplied with the actual tax amount of the corresponding tax. If the cell in I was 0, then, that particular tax will not contribute to reducing the adjusted line amount. (The tax amount for tax the i^{th}tax, Tᵢ, is indicated as Tᵢ itself.)

The following equation holds for the amount for tax the i^{th} tax, Tᵢ:

Tᵢ=(X*Sᵢ+ⱼ₋₁Σⁱ⁻¹M_{i,j}*Tⱼ)*(1+Bᵢ)*(1−ᵣ₌₁Σ^{d}D_{i,r}*dᵣ+ₖ₌₁Σ^{c}C_{i,k}*cₖ)*rᵢ Eqn. 2

This equation can be written as follows, by replacing the underlined terms with the factor kᵢ as essentially, for the i^{th} tax, the set of terms, (1+Bᵢ)*(1−ᵣ₋₁Σ^{d}D_{i,r}*dᵣ+ₖ₋₁Σ^{c}C_{i,k}*cₖ)*rᵢ is nothing but number that can be evaluated as all other variables are known for that tax.

Thus, the equation above can be written as:

Tᵢ=(X*Sᵢ+ⱼ₋₁Σⁱ⁻¹M_{i,j}*Tⱼ)*kᵢ Eqn. 3

It can be demonstrated that equation (3) can be written as:

Tᵢ=X(Sᵢ+ⱼ₋₁Σⁱ⁻¹M_{i,j}*tⱼ)*kᵢ Eqn. 4

where tᵢ is the same as Tᵢ divided by X, i.e.,

tᵢ=Tᵢ/X.

It can be further proved that the term M_{i,j}*tⱼ in equation (4) is:

$$= {k}_{j} * {M}_{i , j}$$

Thus, equation (4) can be re-written as:

Tᵢ=X(Sᵢ+ⱼ₌₁Σⁱ⁻¹M_{i,j}*kⱼ)*kᵢ Eqn. 5

In equation (5), note that on the right hand side of the equation, all terms except X are derivable and/or known. Thus, using this result in equation (1), we have:

L=X+X*(ᵢ₋₁ΣⁿIᵢ*(Sᵢ+ⱼ₋₁Σⁱ⁻¹M_{i,j}*kⱼ)*kᵢ) Eqn. 6

Or:

L=X(1+(ᵢ₋₁ΣⁿIᵢ*kᵢ*(Sᵢ+ⱼ₋₁Σⁱ⁻¹M_{i,j}*kⱼ)) Eqn. 7

And:

$$X = \frac{L}{1 + ( {\sum }_{i = 1}^{n} {I}_{i} * {k}_{i} * ( {S}_{i} + {\sum }_{j = 1}^{i - 1} {M}_{i , j} * {k}_{j} )} \qquad Eqn . 8$$

### Programmatic Implication

The programmatic implication of equations (6) to (8) is that it is possible to compute the Adjusted Line Amount and hence the taxable basis and the tax amounts for any number of inclusive taxes, with some of them being compounded, some of them being surcharges, and affected by base rate modifiers, discounts and charges.

From equation (8), it is clear that the Adjusted Line Amount is affected for the i^{th} tax by the j^{th} tax by the following factors:

If the i^{th} tax is not inclusive, it is not affected at all.

If the i^{th} tax is a surcharge and inclusive, then, the contribution from it is a sum of the products of the factors of the taxes preceding it.

For example, if there are 4 taxes, T₁, T₂, T₃, and T₄, with the corresponding “k” factors, k₁, k₂, k₃, and k₄ and if all of them are inclusive and none are surcharges and their compounding table is as shown below:

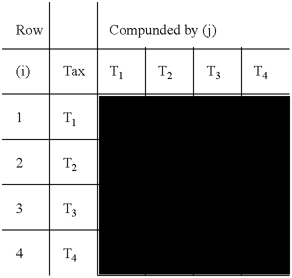

Then, it means that the ALA is=

$$\frac{L}{\begin{matrix}1 + ( {k}_{1} + {k}_{2} + {k}_{3} + {k}_{4} ) + \\ ( {k}_{1} * {k}_{2} + {k}_{1} * {k}_{3} + {k}_{2} * {k}_{3} + {k}_{1} * {k}_{2} )\end{matrix}}$$

It will be apparent to a person skilled in the art that this invention enables the straight forward, step-wise and performant programming to handle extremely complex tax calculation scenarios which hitherto might not have been attempted.

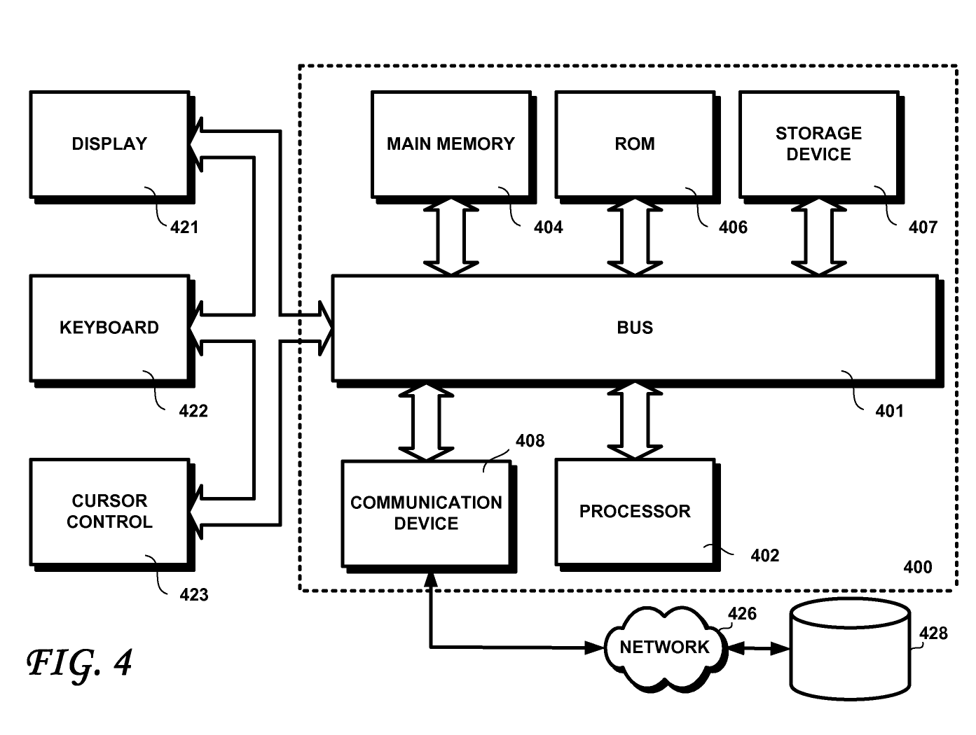

FIG. 4 illustrates a block diagram of a computer system 400 upon which embodiments of the present inventions may be implemented. Computer system 400 may include a bus 401 or other communication mechanism for communicating information, and one or more processors 402 coupled with bus 401 for processing information. Computer system 400 further comprises a random access memory (RAM) or other dynamic storage device 404 (referred to as main memory), coupled to bus 401 for storing information and instructions to be executed by processor(s) 402. Main memory 404 also may be used for storing temporary variables or other intermediate information during execution of instructions by processor 402. Computer system 400 also may include read only memory (ROM) and/or other static storage device 406 coupled to bus 401 for storing static information and instructions for processor 402. A data storage device 407, such as a magnetic disk or optical disk, may be coupled to bus 401 for storing information and instructions. The computer system 400 may also be coupled via the bus 401 to a display device 421 for displaying information to a computer user. An alphanumeric input device 422, including alphanumeric and other keys, may be coupled to bus 401 for communicating information and command selections to processor(s) 402. Another type of user input device is cursor control 423, such as a mouse, a trackball, or cursor direction keys for communicating direction information and command selections to processor 402 and for controlling cursor movement on display 421. The computer system 400 may be coupled, via a communication device (e.g., modem, NIC) to a network 424 and to a repositories or databases 426 of tax content.

Embodiments of the present invention are related to the use of computer system and/or to a plurality of such computer systems for determining the taxable basis of a line item with, for example, inclusive, exclusive and/or compounded taxes. According to one embodiment, the methods and systems described herein may be provided by one or more computer systems 400 in response to processor(s) 402 executing sequences of instructions contained in memory 404. Such instructions may be read into memory 404 from another computer-readable medium, such as data storage device 407. Execution of the sequences of instructions contained in memory 404 causes processor(s) 402 to perform the steps and have the functionality described herein. In alternative embodiments, hard-wired circuitry may be used in place of or in combination with software instructions to implement the present invention. Thus, the present invention is not limited to any specific combination of hardware circuitry and software. Indeed, it should be understood by those skilled in the art that any suitable computer system may implement the functionality described herein. The computer system may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

The data structures and/or pseudo code described in this detailed description are typically stored on a computer readable storage medium, which may be any device or medium that can store code and/or data for use by a computer system. This includes, but is not limited to, magnetic and optical storage devices, such as disk drives, magnetic tape, CDs (compact discs) and DVDs, and computer instruction signals embodied in a transmission medium (with or without a carrier wave upon which the signals are modulated). For example, the transmission medium may include a communications network, such as the Internet.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A computer-implemented method of determining taxable basis amounts for a plurality of applicable taxes for a transaction line having a line amount, comprising:
providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction;
storing the plurality of taxable basis formulae in a database;
selecting one of the stored taxable basis formulae for each of the applicable taxes for the transaction line;
applying the selected taxable basis formula to a line amount of the transaction to compute the taxable basis of the transaction, and
storing the taxable basis of each of the applicable taxes of the transaction line in the database.

2. The computer-implemented method of claim 1, wherein the selecting step includes evaluating a plurality of taxable basis formula determination rules.

3. The computer-implemented method of claim 1, wherein the selecting step is carried out by selecting a default taxable basis formula.

4. The computer-implemented method of claim 1, wherein the plurality of applicable taxes includes a tax that is a surcharge of at least one other applicable tax, and wherein the providing step is carried out with at least one of the plurality of taxable basis formulae including the surcharge.

5. The computer-implemented method of claim 1, wherein the transaction line includes at least one discount, and wherein at least one of the plurality of taxable basis formulae specifies a subtraction of the at least one discount.

6. The computer-implemented method of claim 1, wherein the transaction line includes at least one charge, and wherein at least one of the plurality of taxable basis formulae specifies an addition of the at least one charge.

7. The computer-implemented method of claim 1, wherein the plurality of applicable taxes includes a tax that specifies a base rate modifier, and wherein the providing step is carried out with at least one of the plurality of taxable basis formulae including the base rate modifier.

8. The computer-implemented method of claim 1, further including steps of assigning compounding precedence to taxes that are compounded such that a tax to which a lower compounding precedence has been assigned cannot be compounded by a tax to which a higher compounding precedence has been assigned and wherein the taxable basis formulae determining step is carried out respecting the assigned compounding precedence.

9. The computer-implemented method of claim 1, wherein the selecting step includes obtaining at least one of a tax, a tax regime, a formula type, a taxable basis type for the transaction.

10. The computer-implemented method of claim 1 wherein, for the at least one of the plurality of applicable that includes inclusive taxes, the adjusted line amount is equal to the line amount of the transaction divided by one plus the contributions from inclusive taxes to the taxable basis amount.

11. The computer-implemented method of claim 1, further including a step of, for at least one of the plurality of applicable taxes, computing a net multiplier for each of the inclusive taxes, the net multiplier being configured such that, for each inclusive tax, the line amount multiplied by the net multiplier yields the contribution to the taxable basis amount from the inclusive tax.

12. The computer-implemented method of claim 1, further comprising a step of associating each of the plurality of taxable basis formulae with a tax regime and storing the associated tax regime in the database.

13. The computer-implemented method of claim 1, wherein at least one of the plurality of applicable taxes for the transaction line includes at least one of:
at least one inclusive tax that is compounded with at least one of the plurality of applicable taxes;
at least one inclusive tax that is a surcharge of at least one of the plurality of applicable taxes;
at least one inclusive tax that that is affected by a base rate modifier;
at least one inclusive tax that is affected by additional charges and/or discounts that are allocated to the transaction line, and
an inclusive tax for which the adjusted line amount for that tax is not affected by itself or other inclusive taxes.

14. The computer-implemented method of claim 1, wherein at least one of the plurality of taxable basis formulae computes the taxable basis amount to be the line amount for inclusive taxes.

15. A computer system for determining a taxable basis amount in a transaction having a line amount, the computer system comprising:
at least one processor;
at least one data storage device coupled to the at least one processor;
a plurality of processes spawned by said at least one processor, the processes including processing logic for:
providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction;
storing the plurality of taxable basis formulae in a database;
selecting one of the stored taxable basis formulae for each of the applicable taxes for the transaction line;
applying the selected taxable basis formula to a line amount of the transaction to compute the taxable basis of the transaction, and
storing the taxable basis of each of the applicable taxes of the transaction line in the database.

16. A machine-readable medium having data stored thereon representing sequences of instructions which, when executed by a computing device, causes the computing device to determine a taxable basis amount in a transaction having a line amount, by performing the steps of:
providing and evaluating a plurality of taxable basis formulae, one taxable basis formula for each of the plurality of applicable taxes that includes at least one of inclusive and exclusive taxes, each taxable basis formula being configured to derive an adjusted line amount such that a sum of the adjusted line amount and tax amounts of the inclusive taxes equals the line amount of the transaction;
storing the plurality of taxable basis formulae in a database;
selecting one of the stored taxable basis formulae for each of the applicable taxes for the transaction line;
applying the selected taxable basis formula to a line amount of the transaction to compute the taxable basis of the transaction, and
storing the taxable basis of each of the applicable taxes of the transaction line in the database.
